(19) United States
(12) Patent Application Publication
(10) Pub. No.: US 2008/0191114 A1
(43) Pub. Date: Aug. 14, 2008

(54) Device for Presenting a Visual Object

(76) Inventor: Tulga Yesilaltay, Paris (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/662,101

(22) PCT Filed: Sep. 2, 2005
(86) PCT No.: PCT/EP2005/054328

§ 371 Date: Sep. 10, 2007

(30) Foreign Application Priority Data
Sep. 7, 2004 (FR) 0409441

(51) Int. Cl. A47G 1/16; G09F 1/10

(52) U.S. Cl. 248/472; 40/124

(57) ABSTRACT

The invention concerns a support (100) for presenting a visual object designed to receive a visual object and maintain same in a desired position and/or at a desired distance relative to a background, said support extending generally along a support surface and comprising at least one fixing lug (102, 103, 104, 105), the fixing lug having at least one locating mark (132-135, 142-145) designed to indicate a folding line of the lug (102-105), such that the lug can be arranged in a first storage position wherein the lug is not folded and extends along the support surface or in a so-called extended second position wherein the lug is folded along the folding line(s) and extends projecting relative to the support surface to maintain the object in predetermined positions and/or at predetermined distances relative to the background.

The invention concerns the area of devices for the presentation of visual objects.

It concerns in particular the presentation of objects of generally flat shape such as photographs or pictures.

These objects are generally presented in a support (a frame for example), with the support being placed against a background (a partition or wall for example) by means of securing means (such as picture hooks). This type of presentation does not allow any placement in perspective of the object presented in relation to the background.

Another type of presentation consists of suspending the support in front of the background, by means of a wire or string for example. In this case, the suspension means are visible, and the support is mobile in relation to the background.

The problem solved by the invention is to supply an object presentation device that allows a placement in perspective of the object presented, in relation to a background, and in which the attachment means are discreet.

This problem is solved by means of a support for the presentation of a visual object that is intended to receive a visual object and to hold it in a desired position and/or at a desired distance in relation to a background, with the said support generally lying along a support surface and including at least one securing tab, with the securing tab having at least one location mark intended to indicate a fold line on the tab, so that the tab can be placed in a first storage position in which the tab is not bent and located along the support surface, or in a second position described as deployed, in which the tab is bent along its fold line and so projects in relation to the support surface in order to hold the object in possible predetermined positions and/or at possible predetermined distances in relation to the background.

The tabs are used to hold the object in front of a background, in a given position and/or at a given distance from the background, without being visible to an observer. The support of the invention is therefore discreet.

In addition, the fixing tab allows the stable retention of the object in the space and ensures a relative position of the object in relation to the background, which is not the case when using suspension means such as a wire or string.

The object is exhibited at the front in relation to the background. The support of the invention allows an aesthetic presentation of the object. According to a preferred method of implementation of the invention, the support includes at least two securing tabs.

The support can include a central portion from which extend one or more securing tabs, with the central portion and the securing tabs being advantageously formed as a single part. For example, the support can be formed from a sheet of cardboard or plastic.

In particular, one or more securing tabs can be created by cutting out a central portion of the support.

The invention also concerns a base for the presentation of a visual object, characterised in that it is equipped with at least one slot intended to receive a fixing tab of a support on which the object is placed, with the slot being designed to fit with the tab in order to hold the object at a distance from a background, and in a given position in relation to the background.

In one implementation of the invention, the base includes at least two slots, each slot being intended to receive a fixing tab of the support.

The presentation device combining a support and a base is easy to assemble and allows the presentation of the object to be varied.

Other characteristics and advantages will emerge from the description that follows, which is purely illustrative and not limiting, and which should be read with reference to the appended figures, in which:

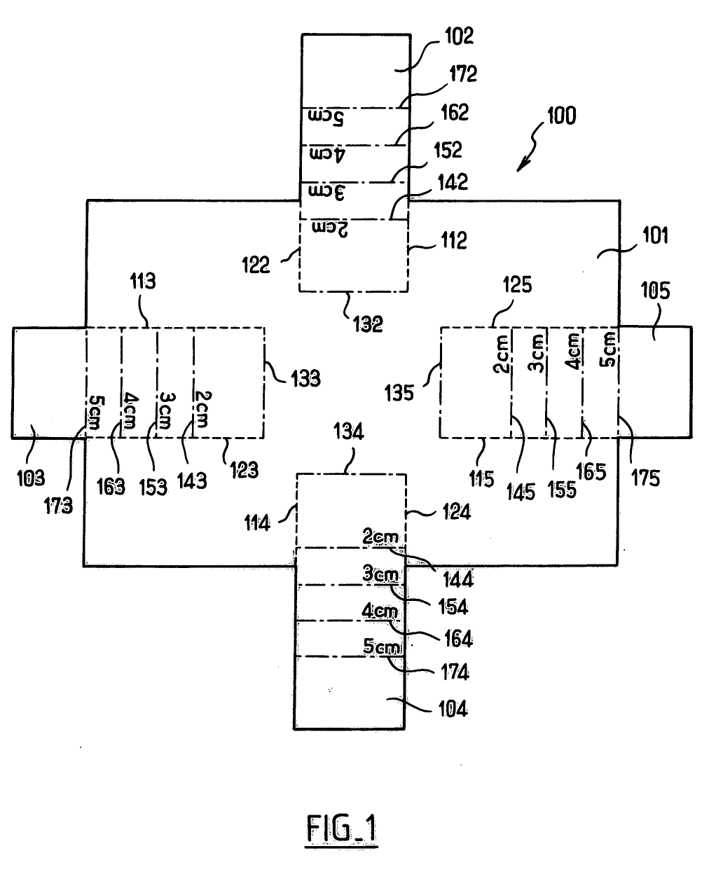

FIGS. 1 to 3 represent examples of presentation supports according to one method of implementation of the invention,

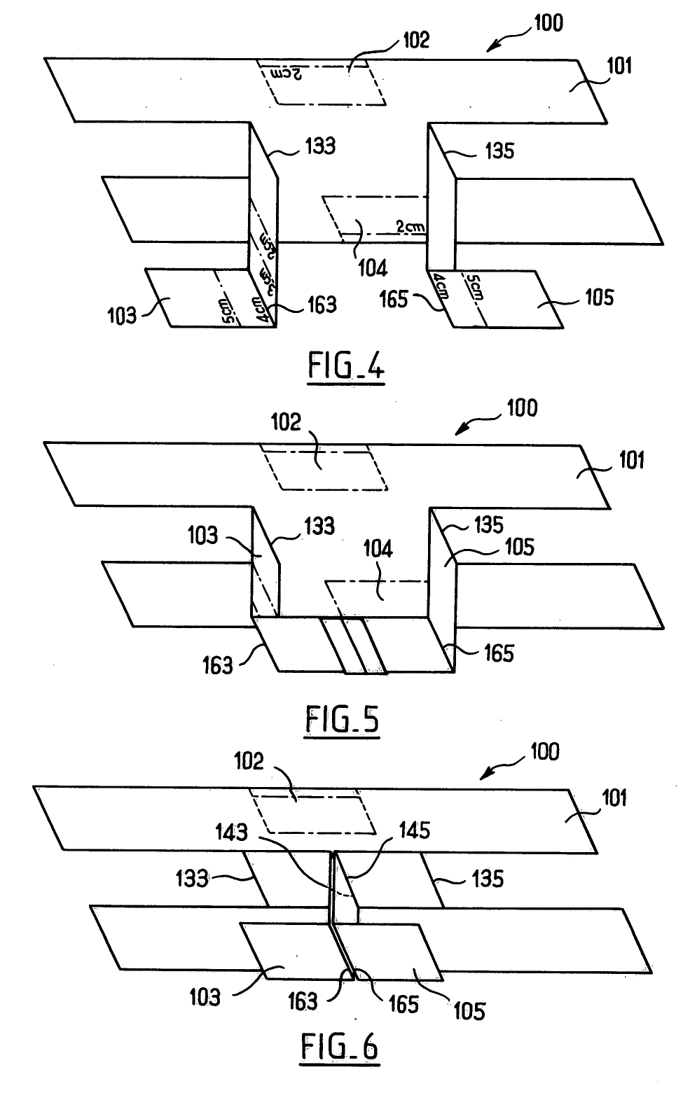

FIGS. 4 to 11 show examples of configurations of the tabs in the support of FIG. 1,

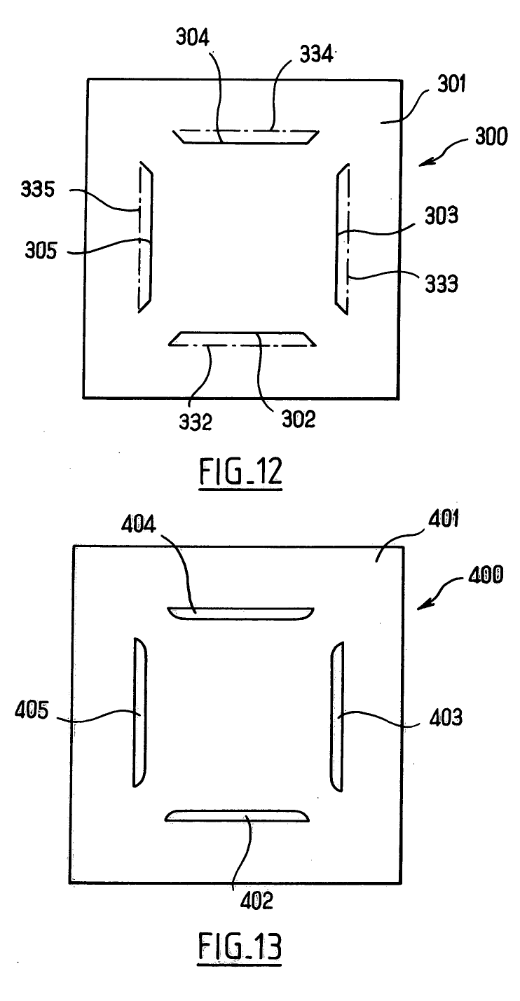

FIGS. 12 to 16 show examples of bases intended to receive presentation supports,

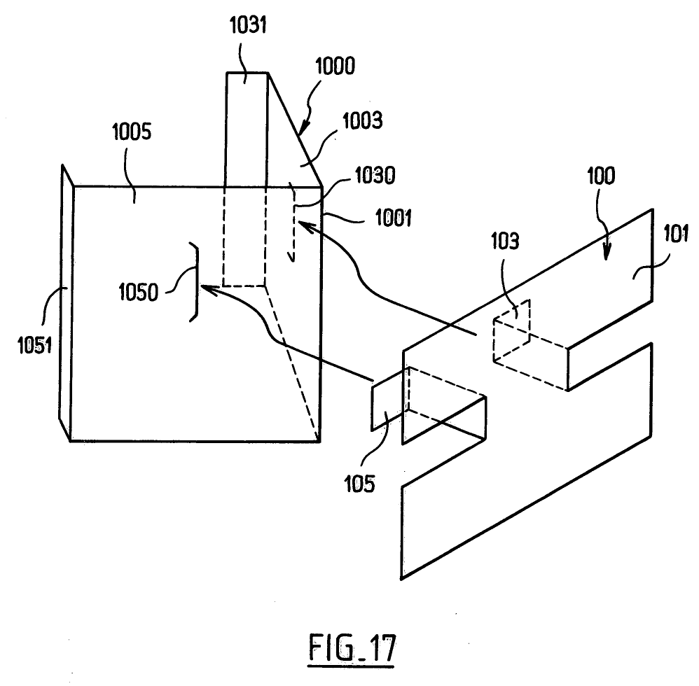

FIG. 17 schematically represents the installation of a support on a base to form a presentation device,

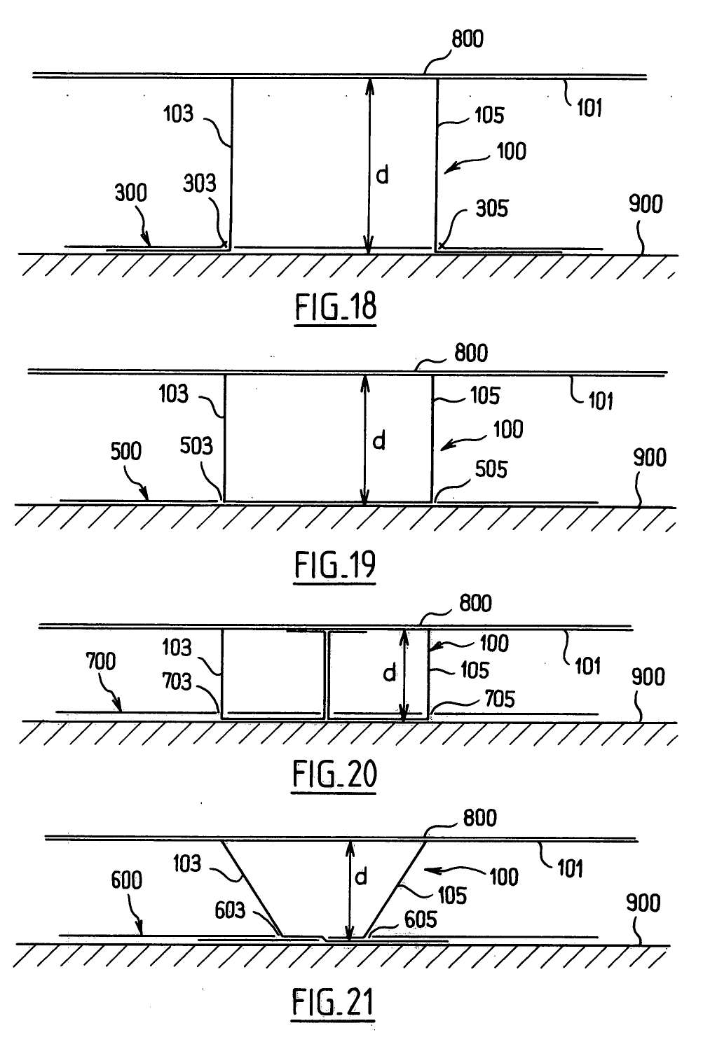

FIGS. 18 to 21 schematically illustrate devices for the presentation of objects, including combinations of a support and a base,

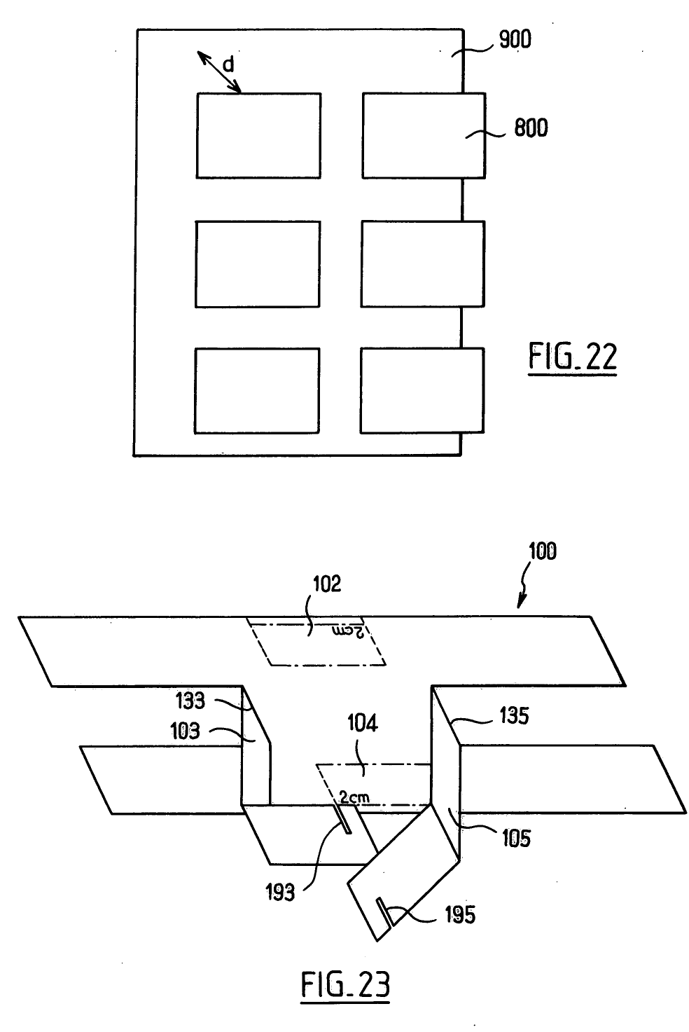

FIG. 22 schematically illustrates one possible presentation example that can be obtained by means of the device for the presentation of the invention,

FIG. 23 schematically illustrates means for the linking together of two fixing tabs between.

FIG. 1 represents a support 100 formed from a sheet of rigid material (such as cardboard or plastic). The support 100 is particularly suitable for the presentation of objects of generally flat shape, such as photos, postcards or pictures.

The support 100 shown includes a central portion 101 of generally rectangular shape, and four fixing tabs 102, 103, 104, 105 extending into the central portion 101. The fixing tabs 102, 103, 104 and 105 are formed partially in the central portion 101. The central portion 101 is intended to receive the object and can, for example, be of standard photo format (10 cm×15 cm, 13 cm×18 cm or other).

To this end, the lateral edges 112, 122, 113, 123, 114, 124, 115, 125 of the fixing tabs 102, 103, 104 and 105 are indicated by pre-cut or weakened lines (shown by broken lines). The weakened lines enable a user to lift the fixing tabs 102, 103, 104 and 105 from the central portion 101.

In a variant of the support 100, the lateral edges 112, 122, 113, 123, 114, 124, 115, 125 of the fixing tabs 102, 103, 104 and 105 are already cut out in the central part 101 of the support. In this variant, the securing tabs 102, 103, 104 and 105 are already formed.

In another variant of the support 100, the edges 112, 122, 113, 123, 114, 124, 115 and 125 of the securing tabs drawn on the support so as to allow a user to cut out the tabs in the central portion 101.

The securing tabs 102, 103, 104 and 105 include locating marks 132, 142, 152, 162, 172, 133, 143, 153, 163, 173, 134, 144, 154, 164, 174, 135, 145, 155, 165, 175 (represented with mixed lines). The locating marks are intended to indicate possible fold lines of the corresponding tab 102 to 105 for the purpose of holding an object presented in predetermined positions and/or at predetermined distances in relation to a background. The securing tabs 102, 103, 104 and 105 are each connected to the central portion 101 by one of their extremities at the locating marks 132, 133, 134 and 135.

In addition, the securing tabs 102, 103, 104 and 105 include indications related to the locating marks, with these indications showing the stand-off distances at which the object can be held in relation to a background.

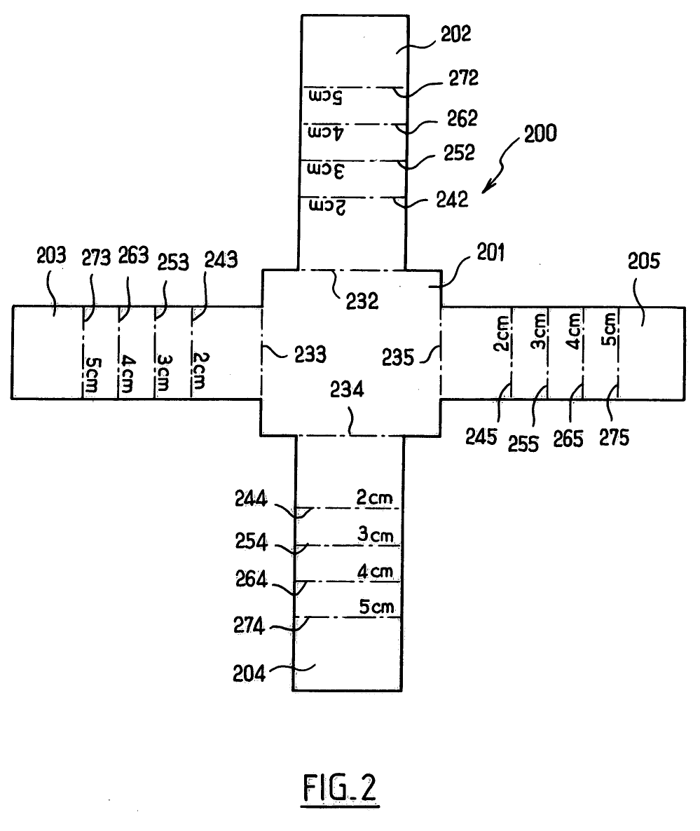

FIG. 2 represents a support 200 similar to the support 100 of FIG. 1, including a central portion 201 of generally rectangular shape from which extend four tabs 202, 203, 204 and 205. In the support 200, the tabs 202, 203, 204 and 205 extend from each of the edges of the central part 101 and are partially not formed in the central portion 201. The tabs 202, 203, 204 and 205 include locating marks 232, 242, 252, 262, 272, 233, 243, 253, 263, 273, 234, 244, 254, 264, 274, 235, 245, 255, 265, and 275 (represented in mixed lines). The tabs are each connected to the central portion 201 at the locating marks 232, 233, 234 and 235 indicating fold lines.

In another implementation (not shown), the support is not formed as a single part. It can include securing tabs attached to the central portion, by glueing for example.

The supports of FIGS. 1 and 2 have the advantage of allowing easy positioning of the fixing tabs in relation to an object to be presented.

On the supports 100 and 200 of FIGS. 1 and 2, the locating marks 132 to 135, 142 to 145, 152 to 155, 162 to 165 and 172 to 175 and 232 to 235, 242 to 245, 252 to 255, 262 to 265 and 272 to 275 correspond to different possible fold lines used to create different possible configurations of the fixing tabs 102 to 105, 202 to 205 when bent along one or more of the fold lines.

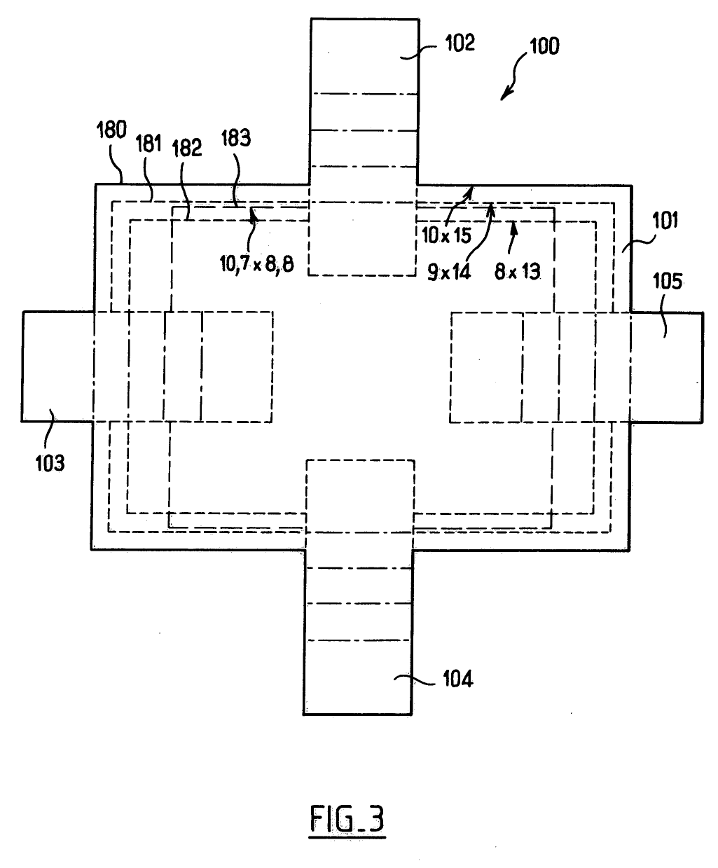

FIG. 3 represents a support 100 that is identical to the support of FIG. 1. The central portion 101 includes locating marks 180, 181, 182 and 183 that are intended to indicate possible positions of photos corresponding to different standard photo formats (10 cm×15 cm, 9 cm×14 cm, 8 cm×13 cm, 10.7 cm×8.8 cm respectively). These locating marks 180, 181, 182 and 183 enable the user to position a photo of standard format in a centred manner in relation to the central portion 101 and to the fixing tabs 101, 102, 103 and 104. The support 100 is thus suitable for the presentation of different photo formats.

The locating marks 181, 182 and 183 can be formed by lines of weakness, that allow to the user to cut the support in order to adapt it to the format of the photo that he wants to mount on the support 100.

In addition, as can be seen in FIG. 3, the central portion includes indications in relation to the locating marks 180, 181, 182 and 183, with these indications showing the photo formats to which the locating marks correspond.

FIGS. 4 to 11 show examples of configurations of the support 100 of FIG. 1, obtained by cutting out two tabs 102 and 104 and by bending two other tabs 103 and 105. The same configurations can also be obtained with the support 200 of FIG. 2.

In FIG. 4, the tabs 102 and 104 located at two opposite sides of the central portion 101 of the support 100 have been cut. The tabs 103 and 105 located at the other two opposite sides of the central part 101 of the support have been lifted off the central portion 101 and folded.

Each tab 103 and 105 has first been folded at a first fold line (corresponding to locating marks 133 and 135) in order to constitute a first tab part extending more or less perpendicular to the central portion 101, on a same side of the central portion 101. Then each tab 103 and 105 has been folded at a second fold line (corresponding to locating marks 163 and 165) in order to constitute a second tab part extending more or less parallel to the central portion 101. The second tab parts thus formed extend in opposite directions to each other, parallel to the central portion 101 to form two L-shaped attachment devices. Folding at the first fold lines (corresponding to locating marks 163 and 165) allows the length of the first tab parts to be adjusted and as a consequence the distance of the central portion 101 of the support 100 in relation to a background.

FIGS. 5 to 11 illustrate other examples of configurations that can be achieved with the same support 100.

In FIG. 5, each tab 103 and 105 has first been folded at a first fold line (corresponding to locating marks 133 and 135) in order to constitute a first tab part extending more or less perpendicular to the central portion 101, on a same side of the central portion 101. Then each tab 103 and 105 has been folded at a second fold line (corresponding to locating marks 163 and 165) in order to constitute a second tab part extending more or less parallel to the central portion 101, with the second tab parts then coming together to form a U-shaped attachment loop.

In FIG. 6, each fixing tab 103 and 105 has first been folded at a first fold line (corresponding to the location marks 133 and 135) in order to constitute a first tab part extending more or less against the central portion 101, on a same side of the central portion 101. Then each tab 103 and 105 has been folded at a second fold line (corresponding to locating marks 143 and 145) in order to constitute a second tab portion located perpendicularly to the central portion 101 on a same side of the central portion 101. Finally, each securing tab 103 and 105 has been bent at a third fold line (corresponding to locating marks 163 and 165) in order to constitute a third tab portion located parallel to the central portion 101, 201. The third parts of the tabs 103 and 105 are then extending in directions opposite to each other to form a T-shaped attachment device.

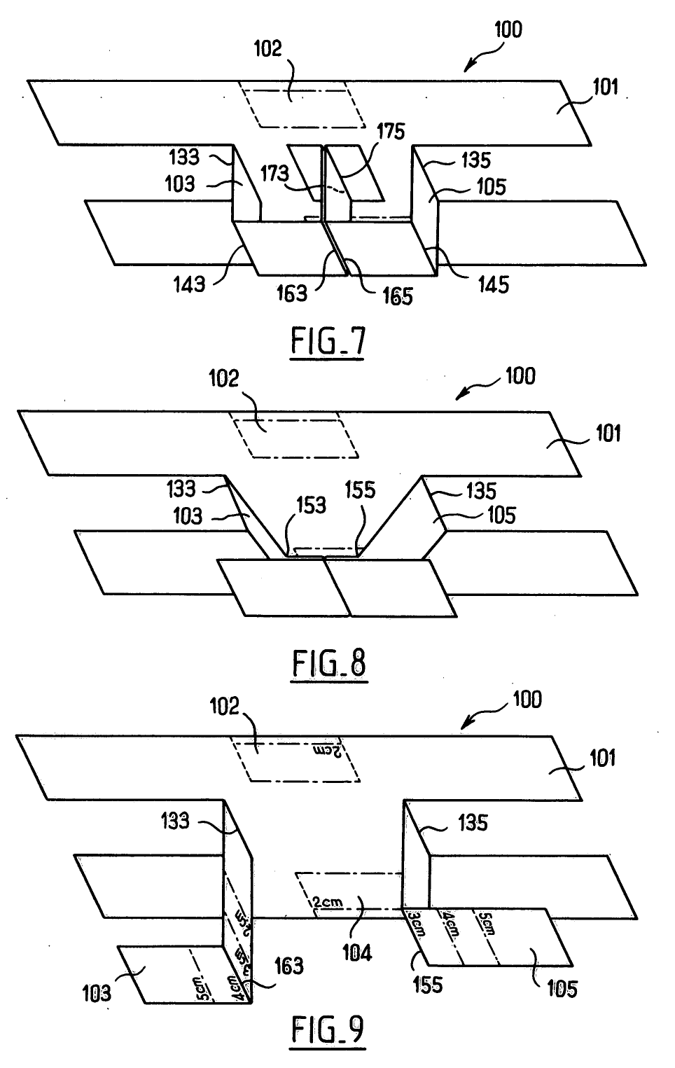

In FIG. 7, each tab 103 and 105 has first been bent at a first fold line (corresponding to locating marks 133 and 135) so as to constitute a first tab portion located substantially perpendicularly to the central portion 101, on a same side of the central portion 101. Then each tab 103 and 105 has been bent at a second fold line (corresponding to locating marks 143 and 145) in order to constitute a second tab portion located substantially parallel to the central portion 101, with the second tab parts joining together. Finally, each tab 103 and 105 has been bent at a third fold line (corresponding to locating marks 163 and 165) in order to constitute a third tab portion located perpendicularly to the central portion 101 and pointing toward the central portion 101 to form two U-shaped attachment loops.

In FIG. 8, each tab 103 and 105 has first been bent at a first fold line (corresponding to locating marks 133 and 135) in order to constitute a first tab portion located at a given angle in relation to the central portion 101, on a same side of the central portion 101. Then each tab 103 and 105 has been bent at a second fold line (corresponding to locating marks 153 and 155) in order to constitute a second tab portion located parallel to the central portion 101, with the second parts of the tab 103 and 105 then coming together to form a generally trapezoid-shaped attachment loop.

In the configurations represented in FIGS. 5 and 8, linking means can be provided to fix the tabs 103 and 105 to each other. These linking means can, for example, be formed by two slots 193 and 195 (as shown in FIG. 23), each of the slots 193 and 195 being cut out in one of the tabs 103 and 105, with the two slots being threaded into each other to connect the tabs 103 and 104 together.

In FIG. 9, the tabs 103 and 105 have been folded in the same way as in the configuration shown in FIG. 3, except that the tabs 103 and 105 have been folded respectively at the locating marks 163 and 155 in opposite directions to each other, with the locating marks 163 and 145 being located at different distances from the central portion 101 of the support 100. In other words, the distance between the first and the second fold lines of tab 103 is different from the distance between the first and the second fold lines of tab 105 so that the first parts of the tabs 103 and 105 are of different lengths. This configuration is used to adjust the slope of the central portion 101 of the support in relation to a background.

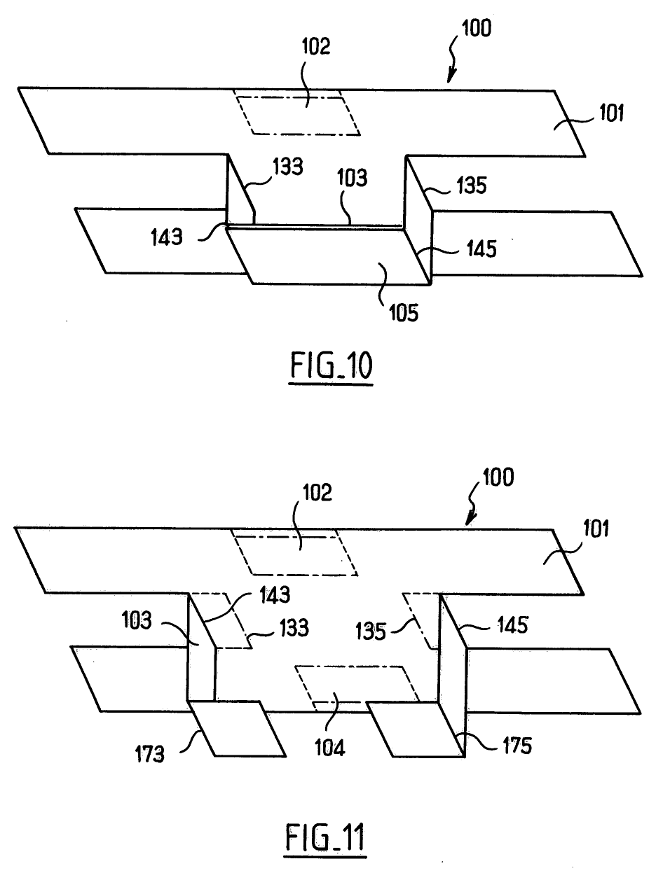

In FIG. 10, the tabs 103 and 105 have been folded in the same way as in the configuration shown in FIG. 5, except that the tabs have been folded respectively at marks 143 and 145 and thus have a larger cover area. In addition, the tabs have been fixed to each other in the cover zone by glueing.

In FIG. 11, tab 103 has been folded at marks 143 and 173 and tab 105 has been folded symmetrically at marks 145 and 175. This configuration is used to create tabs with a larger separation from each other than in the other configurations.

FIGS. 12 to 16 show examples of bases intended to receive a presentation support such as the support 100 or 200 of FIGS. 1, 2 and 3.

The base 300 shown in FIG. 12 is formed from a sheet of rigid material (cardboard or plastic for example). The base 300 includes a central portion 301 with four slots 302, 303, 304 and 305 formed by cutouts executed in the sheet of rigid material and laid out in a square. Each slot 302, 303, 304 and 305 is dimensioned to be able to receive a securing tab 102, 103, 104 and 105 of the support 100 of FIG. 1.

As can be seen in FIG. 12, each cutout forms a tongue which can be lifted away from the central portion 301 by slightly bending the sheet of rigid material along fold lines 332, 333, 334 and 335 (shown in mixed lines). The lifting of the tongues facilitates the introduction of the fixing tabs of the support 100 into slots 332, 333, 334 and 335.

The base 400 shown in FIG. 13 is similar to the base 300 of FIG. 12, except that base 400 includes a central portion with four slots 402, 403, 404 and 405 formed by cutouts that are wider than those executed in the central portion 301 of the base 300 of FIG. 9. The width of the cutouts 402, 403, 404 and 405 is obtained by removing material from portion 401. The width of the cutouts 402, 403, 404 and 405 facilitates the introduction of the fixing tabs of the support 100 into the slots 332, 333, 334 and 335 of the base 400. The bases 300 and 400 represented in FIGS. 12 and 13 are designed particularly to accommodate the presentation support 100, when the latter is in one of the configurations represented in FIGS. 3, 7 or 8.

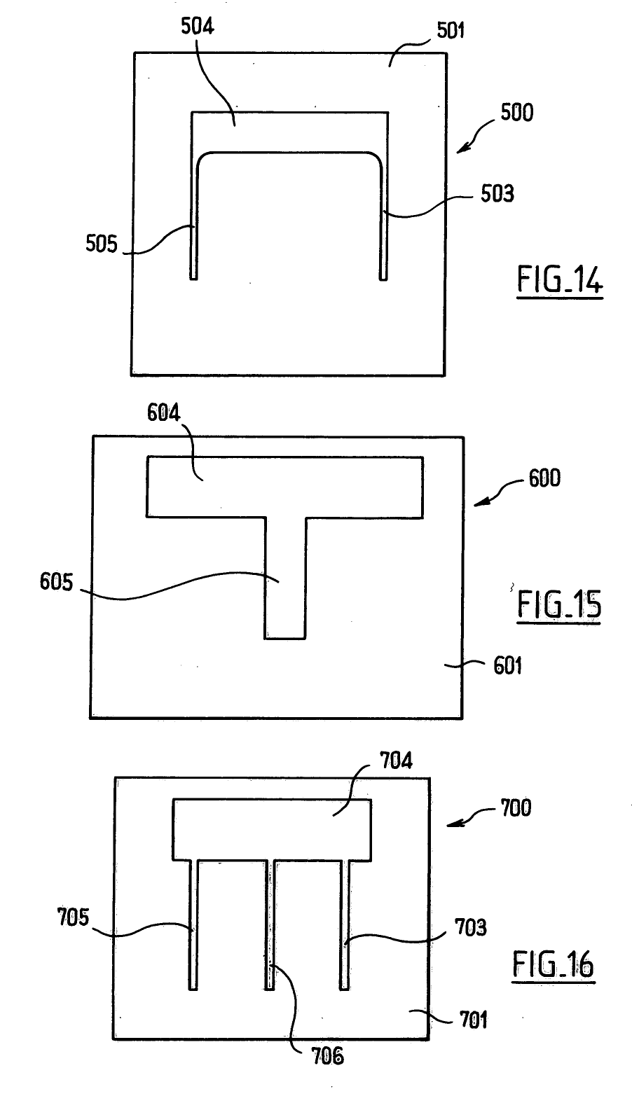

The base 500 of FIG. 14 includes a central portion 501 with a cutout of inverted U shape. The cutout forms a central opening 504 and two parallel slots 503 and 505 joined together at one of their ends by the central opening 504. Each slot 503 and 505 is dimensioned to be able to receive a securing tab 103 and 105 of the support 100 of FIG. 1.

The base 500 shown in FIG. 14 is designed particularly to accommodate the presentation support 100, when the latter is in the configuration shown in FIG. 4. The tabs 103 and 105 are inserted respectively into slots 503 and 505 via opening 504.

The base 600 of FIG. 15 includes a central portion 601 with a T-shaped cutout. The cutout forms an upper horizontal opening 604 and a single central vertical slot 605. The central slot 605 is dimensioned to receive two securing tabs 103 and 105 of the support 100 of FIG. 1.

In particular, the base 600 shown in FIG. 15 is designed to receive the presentation support 100, when the latter is in one of the configurations represented in FIGS. 1, 7 or 8. The tabs 103 and 105 are inserted into the slot 605 via the upper opening 604.

The base 700 shown in FIG. 16 includes a central portion 601 with a cutout. The cutout forms an upper horizontal opening 704 and three vertical slots 703, 705, 706 extending from the central opening 704. Each of the lateral slots 703 and 705 is dimensioned to receive respectively a fixing tab 103 and 105 of the support 100 of FIG. 1. The central slot 705 is dimensioned to receive two securing tabs 103 and 105 of the support 100 of FIG. 1.

In particular, the base 700 shown in FIG. 16 is designed to receive the presentation support 100, when the latter is in the configuration shown in FIG. 6. The tabs 103 and 105 are inserted into the slots 703, 705 and 706 via the upper opening 704.

FIG. 17 schematically illustrates the installation of a support 100 on a base 1000 to form a presentation device. The support 100 is in the configuration of FIG. 4, with two tabs 103 and 105 forming two L-shaped attachment devices.

The support 1000 takes the form of a corner piece formed from a sheet of rigid material, including two wings 1003 and 1005 connected to each other by a common edge 1001. Each of the wings 1003 and 1005 has a slot 1030 and 1050 respectively. Each slot 1030 and 1050 is dimensioned to be able to receive one of the tabs 103 and 105 of the support 100.

In addition, the wings 1003 and 1005 include tongues 1031 and 1051 used to fix the base 1000 onto two wall surfaces forming an angle between them. The base 1000 is used advantageously to fix the presentation device in the corner of a room.

FIG. 18 schematically illustrates, in cross section, an object presentation device with, in combination, the support 100 in the configuration of FIG. 4 and the base 300 of FIG. 12. As can be seen in FIG. 18, the bent parts of the fixing tabs 103 and 105 of the support 100 have been inserted into the slots 303 and 305 of the base 300. An object to be presented 800 has been placed on the central portion 101 of the support 100 and the base 300 is fixed to a background 900 (such as a wall).

FIG. 19 schematically illustrates, in cross section, an object presentation device that includes, in combination, the support 100 in the configuration of FIG. 5 and the base 500 of FIG. 14. As can be seen in FIG. 19, the bent parts of the fixing tabs 103 and 105 of the support 100 have been inserted into the slots 503 and 505 of the base 500. An object to be presented 800 has been fixed on the central portion 101 of the support 100 and the base 500 is fixed to a background 900.

FIG. 20 schematically illustrates, in cross section, an object presentation device that includes, in combination, the support 100 in the configuration of FIG. 6 and the base 700 of FIG. 16. As can be seen in FIG. 20, the bent parts of the fixing tabs 103 and 105 of the support 100 have been inserted into the slots 703 and 705 of the base 700. An object to be presented 800 has been fixed on the central portion 101 of the support 100 and the base 700 is fixed to a background 900.

FIG. 21 schematically illustrates, in cross section, an object presentation device that includes, in combination, the support 100 in the configuration of FIG. 8 and the base 600 of FIG. 15. As can be seen in FIG. 21, the bent parts of the fixing tabs 103 and 105 of the support 100 have been inserted into the slots 603 and 605 of the base 600. An object to be presented 800 has been fixed on the central portion 101 of the support 100 and the base 700 is fixed to a background 900.

In FIGS. 18 to 21, the securing tabs 103 and 105 hold the object to be presented 800 in relation to the background 900 at a given distance d from the background.

FIG. 22 schematically illustrates, in a front view, a multiplicity of objects 800 presented in front of a background by means of presentation devices according to the invention. The objects are held in relation to a background 900 at a given distance d from the background. The securing tabs of the fixing devices are invisible to an observer contemplating the objects 800 from the front.

In FIG. 18, the objects are presented parallel to the background 900. It is also possible however, using the presentation device of the invention, to present the objects 800 at an angle in relation to the background 900. To this end, it suffices to use the securing tabs of the support in the configuration shown in FIG. 8. This can be particularly advantageous especially to present an object at height or close to the ground, or close to a corner of a room.

The securing device that has just been described includes a support that has tabs, where the support is designed to receive the object to be presented and a base that includes slots, where the base is intended to be fixed to a background. It is obvious of course that the proposed base and support can be reversed. To this end, the support with the tabs can be fixed to a background and the base with the slots can receive the object to be presented, with the base and the support fitting together in the same way as before.

1. A support (100, 200) for the presentation of a visual object (800) intended to receive a visual object (800) and to hold it in a given position and/or at a desired distance in relation to a background (900), with the said support located generally along a support surface and including at least one securing tab (102, 103, 104, 105, 202, 203, 204, 205), with the securing tab having at least one location mark (132-135, 142-145, 232-235, 242-245) intended to indicate a fold line on the tab (102 105, 202-205), so that the tab can be positioned in a first storage position in which the tab is not bent and located along the support surface or in a second position, described as deployed, in which the tab is bent along its fold line and so projects in relation to the support surface in order to hold the object (800) in position and/or at possible predetermined distances in relation to the background (900).

2. A support according to claim 1, including at least two fixing tabs (102, 103, 104, 105).

3. A support according to either of claims 1 or 2, including a central portion (101, 201) from which extend one or more securing tabs (102, 103, 104, 105, 202, 203, 204, 205), with the central portion and the fixing tabs being formed as a single part.

4. A support according to claim 3, in which one or more securing tabs (102, 103, 104, 105) are cut out in the central portion (101) of the support (100).

5. A support according to claim 3, in which one or more securing tabs (102, 103, 104, 105) are defined by weakened lines in the central portion (101) of the support (100).

6. A support according to either of claims 1 or 2, including a central portion (101, 201) from which extend one or more securing tabs (102, 103, 104, 105, 202, 203, 204, 205), in which the tab or tabs are attached to the central portion (101, 201).

7. A support according to claim 6, in which the central portion (101) includes locating marks (180, 181, 182, 183) intended to indicate possible positions of photos.

8. A support according to one of the preceding claims, this support being formed from a sheet of cardboard or of plastic.

9. A support according to claim 8, in which one or more securing tabs (102-105, 202-205) include indications related to one or more location marks (132-135, 142-145, 232-235, 242-245), where these indications show the stand-off distance in relation to the background (900).

10. A support according to either of claims 8 or 9, in which the locating marks (132-135, 142-145, 232-235, 242-245) correspondent to different possible fold lines for the purpose of creating different possible configurations of the fixing tab (102-105, 202-205) when folded along one or more of the fold lines.

11. A support according to one of claims 8 to 10, including a central portion (101) and at least two securing tabs (103, 105), with the locating marks (132-135, 142-145, 152-155, 162-165, 172-175) being placed on each fixing tab (103, 105) so as to indicate first and second fold lines (133, 135, 163, 165), with the first fold line (133, 135) of each tab (103, 105) being used to bend the said tab (103, 105) in order to constitute a first tab part extending more or less perpendicular to the central portion (101), on a same side of the central portion (101), and the second fold line (163, 165) of each tab (103, 105) used to bend the said tab (103, 105) in order to constitute a second tab part extending parallel to the central portion (101), with the second tab parts then extending in opposite directions to each other to form two L-shaped attachment devices.

12. A support according to claim 11, in which the locating marks (132-135, 142-145, 152-155, 162-165, 172-175) are placed so that the distance between the first and the second fold line (133, 163) of one of the tabs (103) is different from the distance between the first and the second fold line (135, 155) of the other tab (105) so that the first parts of the tabs (103, 1015) are of different lengths.

13. A support according to one of claims 8 to 10, including a central portion (101, 201) and at least two fixing tabs (103, 105, 106), with the locating marks (132-135, 142-145, 152-155, 162-165, 172-175) positioned on each securing tab (102, 105) so as to indicate first and second fold lines (133, 135, 143, 145), where the first fold line (133, 135) of each tab (103, 105) is used to bend the said tab (103, 105) in order to constitute a first tab portion located substantially perpendicularly to the central portion (101), on a same side of the central portion (101) and where the second fold line (163, 165) of each tab (103, 105) is used to bend the said tab (103, 105) in order to constitute a second tab portion located parallel to the central portion (101), with the second tab parts then coming together to form a U-shaped attachment loop.

14. A support according to one of claims 8 to 10, including a central portion (101) and at least two fixing tabs (103, 105), with the locating marks (132-135, 142-145, 152-155, 162-165, 172-175) being positioned on each securing tab (102-105) so as to indicate first, second and third fold lines (133, 135, 143, 145, 163, 165), with the first fold line (133, 135) of each tab (103, 105) being used to bend the said tab (103, 105) in order to constitute a first tab portion located substantially against the central portion (101) on a same side of the central portion (101), the second fold line (143, 145) of each tab (103, 105) being used to bend the said tab (103, 105) in order to constitute a second tab portion located perpendicularly to the central portion (101) on a same side of the central portion (101), and the third fold line (163, 165) of each tab (103, 105) being used to bend the said tab (103, 105) in order to constitute a second tab portion located parallel to the central portion (101), with the third tab parts then lying in directions opposite to each other to form a T-shaped attachment device.

15. A support according to one of claims 8 to 10, including a central portion (101) and at least two securing tabs (103, 105), with the locating marks (132-135, 142-145, 152-155, 162-165, 172-175) being positioned on each fixing tab (102, 105) so as to indicate first, second and third fold lines (133, 135, 143, 145, 163, 165), with the first fold line (133, 135) of each tab (103, 105) being used to bend the said tab (103, 105) in order to constitute a first tab part extending more or less perpendicular to the central portion (101), on a same side of the central portion (101), the second fold line (143, 145) of each tab (103, 105) being used to bend the said tab (103, 105) in order to constitute a second tab part extending parallel to the central portion (101), with the second tab parts coming together, and the third fold line (163, 165) of each tab (103, 105) being used to bend the said tab (103, 105) in order to constitute a third tab part extending perpendicular to the central portion (101) toward the central portion (101) to form U-shaped attachment loops.

16. A support according to one of claims 8 to 10, including a central portion (101) and at least two securing tabs (103, 105), with the locating marks (132-135, 142-145, 152-155, 162-165, 172-175) being positioned on each fixing tab (103, 105) so as to indicate first and second fold lines (133, 135, 153, 155) of each tab (103, 105) used to bend the said tab (103, 105) in order to constitute a first tab part extending at a given angle in relation to the central portion (101), on a same side of the central portion (101), and the second fold line (153, 155) of each tab (103, 105) used to bend the said tab (103, 105) in order to constitute a second tab part extending parallel to the central portion (101), the second tab parts then coming together to form an attachment loop of general trapezoid shape.

17. A base (300, 400, 500, 600, 700) for the presentation of a visual object (800), characterised in that it is provided with at least one slot (302-305, 402-405, 503, 505, 605, 703, 704, 706) intended to receive a securing tab (102-105, 202-205) of a support (100, 200) according to one of claims 1 to 16, on which the object (800) is placed, with the slot (302-305) being designed to cooperate with the tab (102-105, 202-205) in order to hold the object (800) at a distance (d) from a background (900) in a given position in relation to the background (900).

18. A base according to claim 17, characterised in that it includes at least two slots (302-305, 402-405, 503, 505, 703, 704, 706), each slot being intended to receive a securing tab (102-105, 202-205) of the support (100, 200).

19. A device for the presentation of a visual object (800), characterised in that it includes:
a presentation support according to one of claims 1 to 16,
a base (300, 400, 500, 600, 700) according to either of claims 17 or 18.
